(19) United States
(12) Patent Application Publication
(10) Pub. No.: US 2008/0299391 A1
(43) Pub. Date: Dec. 4, 2008

(54) CAPSULES, METHODS FOR MAKING CAPSULES, AND SELF-HEALING COMPOSITES INCLUDING THE SAME

(76) Inventors: Scott R. White, Champaign, IL (US); Nancy R. Sottos, Champaign, IL (US); Benjamin J. Blaiszik, Urbana, IL (US)

Correspondence Address: EVAN LAW GROUP LLC, 600 WEST JACKSON BLVD., SUITE 625, CHICAGO, IL, 60661, US

(21) Appl. No.: 11/756,280

(22) Filed: May 31, 2007

(51) Int. Cl. B32B 5/16; C08G 61/02; C08G 73/02; C08L 25/06

(52) U.S. Cl. 428/402.21; 526/346; 528/368; 528/48

(57) ABSTRACT

A composition includes a plurality of capsules, and a polymerizer in the capsules. The capsules have an average outer diameter less than 10 micrometers. The capsules can be made by sonicating an emulsion to form a microemulsion, where the emulsion includes water, a surfactant, a first polymerizer and a second polymerizer, and then polymerizing the first polymerizer. The capsules may be present in a composite material that includes a polymer matrix and an activator.

### FEDERALLY SPONSORED RESEARCH OR DEVELOPMENT

The subject matter of this application may have been funded in part under a research grant from the National Science Foundation Center for Nanoscale Chemical-Electrical-Mechanical Manufacturing Systems, under grant number DMI 03-28162 COOP, and a research grant from the Air Force Office of Scientific Research under grant number F49620-03-1-0179. The U.S. Government may have rights in this invention.

### BACKGROUND

Cracks that form within materials can be difficult to detect and almost impossible to repair. A successful method of autonomically repairing cracks that has the potential for significantly increasing the longevity of materials has been described, for example, in U.S. Pat. No. 6,518,330. This self-healing system includes a material containing, for example, solid particles of Grubbs catalyst and capsules containing liquid dicyclopentadiene (DCPD) embedded in an epoxy matrix. When a crack propagates through the material, it ruptures the microcapsules and releases DCPD into the crack plane. The DCPD then mixes with the Grubbs catalyst, undergoes Ring Opening Metathesis Polymerization (ROMP), and cures to provide structural continuity where the crack had been.

Crack formation in thin films can be especially problematic. Examples of thin film materials that could benefit from having self-healing properties include adhesives and microelectronic components. The thickness dimensions of thin films are similar to the dimensions of conventional components of self-healing systems. Capsules containing a self-healing agent typically have had outer diameters on the order of 30 to 1,000 micrometers. This similarity in dimensions can make it difficult to provide homogenous distribution of self-healing components within the matrix of a thin film. In addition, it may be difficult to make films having smooth surface features.

It is desirable to provide smaller capsules that contain a self-healing agent, and that can impart self-healing properties to materials into which they are incorporated. It is also desirable for these smaller capsules to have appropriate levels of strength, shelf life, temperature stability, and bonding to the matrix material that can allow for effective self-healing.

### SUMMARY

In one aspect, the invention provides a composition that includes a plurality of capsules, and a polymerizer in the capsules. The capsules have an average outer diameter less than 10 micrometers.

In another aspect, the invention provides a method of making capsules that includes sonicating an emulsion to form a microemulsion. The emulsion includes water, a surfactant, a first polymerizer, and a second polymerizer. The method further includes polymerizing the first polymerizer to form capsules encapsulating at least a portion of the second polymerizer.

In another aspect, the invention provides a composite material that includes a polymer matrix, a plurality of capsules, a polymerizer in the capsules, and an activator. The capsules have an average outer diameter less than 10 micrometers.

In another aspect, the invention provides a method of making the composite material that includes combining the plurality of capsules and the activator with a matrix precursor, and solidifying the matrix precursor to form the polymer matrix.

The following definitions are included to provide a clear and consistent understanding of the specification and claims.

The term “capsule” means a closed object having an aspect ratio of 1:1 to 1:10, and that may contain a solid, liquid, gas, or combinations thereof. The aspect ratio of an object is the ratio of the shortest axis to the longest axis, where these axes need not be perpendicular. A capsule may have any shape that falls within this aspect ratio, such as a sphere, a toroid, or an irregular ameboid shape. The surface of a capsule may have any texture, for example rough or smooth.

The term “outer diameter” of a capsule means the average of the outer diameters of the capsule.

The term “average” of a dimension of a plurality of capsules means the average of that dimension for the plurality. For example, the term “average outer diameter” of a plurality of capsules means the average of the outer diameters of the capsules, where an outer diameter of a single capsule is the average of the outer diameters of that capsule. Likewise, the term “average wall thickness” of a plurality of capsules means the average of the wall thicknesses of the capsules, where a wall thickness of a single capsule is the average of the wall thicknesses of that capsule.

The term “polymerizer” means a composition that will form a polymer when it comes into contact with a corresponding activator for the polymerizer. Examples of polymerizers include monomers of polymers, such as styrene, ethylene, acrylates, methacrylates and dicyclopentadiene (DCPD); one or more monomers of a multi-monomer polymer system, such as diols, diamines and epoxides; prepolymers such as partially polymerized monomers still capable of further polymerization; and functionalized polymers capable of forming larger polymers or networks.

The term “polymer” means a substance containing more than 100 repeat units. The term “polymer” includes soluble and/or fusible molecules having long chains of repeat units, and also includes insoluble and infusible networks. The term “prepolymer” means a substance containing less than 100 repeat units and that can undergo further reaction to form a polymer.

The term “activator” means anything that, when contacted or mixed with a polymerizer, will form a polymer. Examples of activators include catalysts and initiators. A corresponding activator for a polymerizer is an activator that, when contacted or mixed with that specific polymerizer, will form a polymer.

The term “catalyst” means a compound or moiety that will cause a polymerizable composition to polymerize, and that is not always consumed each time it causes polymerization. This is in contrast to initiators, which are always consumed at the time they cause polymerization. Examples of catalysts include ring opening polymerization (ROMP) catalysts such as Grubbs catalyst. Examples of catalysts also include silanol condensation catalysts such as titanates and dialkyltincarboxylates. A corresponding catalyst for a polymerizer is a catalyst that, when contacted or mixed with that specific polymerizer, will form a polymer.

The term “initiator” means a compound or moiety that will cause a polymerizable composition to polymerize and, in contrast to a catalyst, is always consumed at the time it causes polymerization. Examples of initiators include peroxides, which can form a radical to cause polymerization of an unsaturated monomer; a monomer of a multi-monomer polymer system, such as a diol, a diamine, and an epoxide; and amines, which can form a polymer with an epoxide. A corresponding initiator for a polymerizer is an initiator that, when contacted or mixed with that specific polymerizer, will form a polymer.

The term “emulsion” means a combination of at least two liquids, where one of the liquids is present in the form of droplets in the other liquid. (IUPAC (1997)). The term “emulsion” includes microemulsions.

The term “polymer matrix” means a continuous phase in a material, where the continuous phase includes a polymer.

The term “matrix precursor” means a composition that will form a polymer matrix when it is solidified. A matrix precursor may include a monomer and/or prepolymer that can polymerize to form a polymer matrix. A matrix precursor may include a polymer that is dissolved or dispersed in a solvent, and that can form a polymer matrix when the solvent is removed. A matrix precursor may include a polymer at a temperature above its melt temperature, and that can form a polymer matrix when cooled to a temperature below its melt temperature.

### BRIEF DESCRIPTION OF THE DRAWINGS

The invention can be better understood with reference to the following drawings and description. The components in the figures are not necessarily to scale, emphasis instead being placed upon illustrating the principles of the invention.

FIG. 1 represents a method of making capsules.

FIG. 2 is an illustration of a self-healing composite, in which a crack has been initiated (FIG. 2A), in which the crack has progressed to release a polymerizer (FIG. 2B), and in which the crack has been healed by the formation of a polymer from the polymerizer and an activator (FIG. 2C).

FIG. 3 is a scanning electron microscopy (SEM) image of capsules.

FIG. 4 is a graph of average outer diameter for capsules formed from mixtures having different concentrations of costabilizers.

FIG. 5 is an SEM image of capsules formed from a mixture including a costabilizer.

FIG. 6 is a transmission electron microscopy (TEM) image of capsules formed from a mixture including a costabilizer.

### DETAILED DESCRIPTION

The present invention makes use of the discovery that a self-healing agent can be encapsulated in capsules having an average outer diameter less than 10 micrometers. The interior volume of the capsules can be less than 5 picoliters. The capsules may be resistant to aggregation, and may be uniformly dispersed in a polymer matrix. Other advantageous features of the capsules may include smooth capsule surfaces, good temperature stability, long shelf life, and contribution to fracture toughening of a polymer matrix. The capsules having an average diameter less than 10 micrometers are much smaller than capsules used in conventional self-healing materials, and may provide self-healing properties on much smaller scales, such as for healing microscale failures and/or for use in thin films, coatings, and adhesives. The capsules may be present in a composite material that includes a polymer matrix and an activator for the polymerizer that is present in the capsules.

A method for making capsules having an average outer diameter less than 10 micrometers includes sonicating an emulsion to form a microemulsion, where the emulsion includes water, a surfactant, a first polymerizer and a second polymerizer. The method further includes polymerizing the first polymerizer to form capsules encapsulating at least a portion of the second polymerizer.

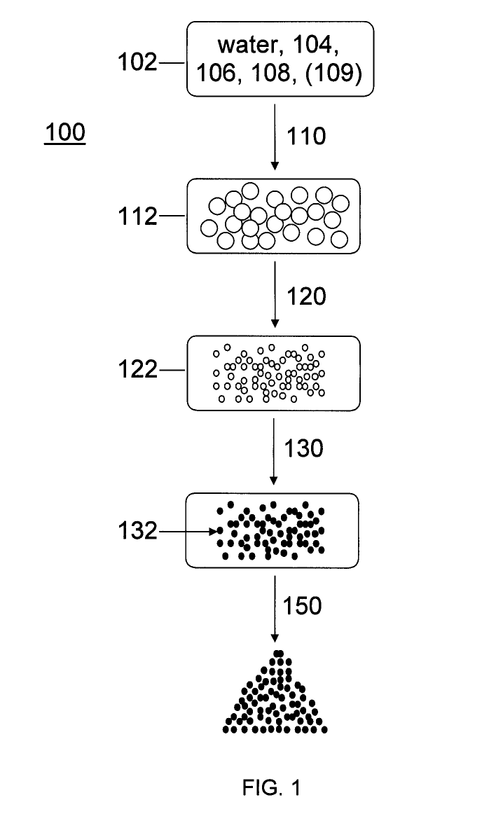

FIG. 1 represents an example of a method 100 for forming capsules containing a polymerizer and having an average outer diameter less than 10 micrometers. Method 100 includes dispersing (110) a mixture 102 to form an emulsion 112, sonicating (120) the emulsion to form a microemulsion 122, polymerizing (130) a first polymerizer to form capsules 132, and collecting (150) the capsules.

A mixture 102 for forming capsules includes water, a surfactant 104, a first polymerizer 106, and a second polymerizer 108. Optionally, mixture 102 may include one or more additional components, such as buffering components, salts, acids, bases, and organic compounds that are suitable as adhesives, fibers, or costabilizers 109. The first and second polymerizers are immiscible with water, and form an organic phase in the mixture 102.

The surfactant 104 preferably can reduce the interfacial tension between the aqueous phase and the organic phase to 5×10⁻³ Newtons per meter (N/m) or less. Preferably the surfactant is more soluble in the aqueous phase so as to be readily available for adsorption on an organic droplet surface. Preferably the surfactant can adsorb strongly to organic phase droplets and is not easily displaced when two droplets collide. In addition, the surfactant may impart a sufficient electrokinetic potential to the emulsion droplets to stabilize the droplets. Preferably the surfactant can be effective at low concentrations in the mixture 102 and is relatively inexpensive, non-toxic and safe to handle.

Surfactant 104 may include an ionic surfactant, such as a cationic surfactant, an anionic surfactant, or an amphoteric surfactant. Examples of cationic surfactants include cetyltrimethyl-ammonium bromide (CTAB), hexadecyltrimethylammonium bromide (HTAB), dimethyldioctadecylammonium bromide (DDAB), and methylbenzethonium chloride (Hyamine™). Examples of anionic surfactants include sodium dodecyl sulfate, sodium lauryl sulfate, sodium hexadecyl sulfate, sodium laureth sulfate, ammonium laureth sulfate, TEA-lauryl sulfate TEA-laureth sulfate, MEA-lauryl sulfate, MEA-laureth sulfate, potassium lauryl sulfate, potassium laureth sulfate, sodium decyl sulfate, sodium octyl/decyl sulfate, sodium 2-ethylhexyl sulfate, sodium octyl sulfate, sodium a-olefin sulfonate, alkyl phenol ether sulfate, sodium nonoxynol-4 sulfate, sodium nonoxynol-6 sulfate, ammonoium nonoxynol-6 sulfate, disodium polyoxyethylenenated nonylphenol half ester of sulphosuccinic acid, ammonium sulfated nonylphenoxy poly((ethylenoxy) ethanol (4 ethyleneoxide)), disodium lauryl sulfosuccinate, disodium laureth sulfosuccinate, sodium cocoyl isethionate, ammonium xylene sulfonate, sodium xylene sulfonate, sodium toluene sulfonate, sodium cumene sulfate, lauryl phosphate, bile salts (such as sodium deoxycholate, sodium cholate). Examples of amphoteric surfactants include cocoamidopropyl betaine, laurylamidopropyl betaine, and ester surfactants such as lauryl dimethyl amine oxide and cocoamidopropyl dimethyl amine oxide.

Surfactant 104 may include a non-ionic surfactant, such as a polysorbate (Tween™), a polyethoxylated alcohol, polyoxyethylene sorbitan, octoxynol (Triton X100™), N,N-dimethyidodecyl-amine-N-oxide, Polyoxyl 10 lauryl ether, Brij® 721, Brij®35, polyvinyl alcohol, poly(methyl methacrylate-b-2-(dimethylamino)ethyl methacrylate) block copolymer, nonylphenol ethoxylate (Tergitol™), cyclodextrin, lecithin, cocoamide DEA, cocoamide MEA, ethylene glycol monostearate, ethylene glycol distearate, and ethylene-maleic anhydride copolymer. Preferably the surfactant 104 is a non-ionic surfactant. More preferably, the surfactant 104 is ethylene-maleic anhydride (EMA) copolymer.

The optimum concentration of surfactant 104 in mixture 102 may be determined empirically. If there is too little surfactant, the walls of capsules 132 may have a thick layer of excess capsule polymer, and/or the capsules may be prone to form aggregates. Preferably the amount of surfactant 104 present is the minimum amount required to avoid aggregation of the capsules 132.

The first polymerizer 106 may include any polymerizer that can be polymerized in an emulsion, and that can be polymerized independent of the second polymerizer. In one example, the first polymerizer may include a polyurethane precursor, such as a diol, a diisocyanate, and/or a monomer containing both alcohol and isocyanate functional groups. In another example, the first polymerizer may include a urea-formaldehyde polymer precursor, such as urea and/or formaldehyde. In another example, the first polymerizer may include a gelatin precursor, such as soluble gelatin that may form gelatin by complex coacervation. In another example, the first polymerizer may include a polyurea precursor, such as an isocyanate and/or an amine such as a diamine or a triamine. In another example, the first polymerizer may include a polystyrene precursor, such as styrene and/or divinylbenzene. In another example, the first polymerizer may include a polyamide precursor, such as an acid chloride and/or a triamine. Preferably the first polymerizer includes urea as a urea-formaldehyde polymer precursor.

The second polymerizer 108 may include any polymerizer that can be polymerized independent of the first polymerizer. At least a portion of the second polymerizer 108 is present in the capsules 132 formed by process 100. The second polymerizer forms a polymer when contacted with a corresponding activator for the second polymerizer. Preferably the second polymerizer can form a polymer in a crack in a material in which the capsules are dispersed.

The optional costabilizer 109 may include compounds that stabilize organic phase droplets in an emulsion. The costabilizer 109 may be a low-molecular weight compound that is insoluble in water, such as cetyl alcohol, hexadecane, octane, or n-dodecyl mercaptan. The costabilizer 109 may be a polymer that is insoluble in water, such as poly(methyl methacrylate) or polystyrene. Preferably the costabilizer 109 is octane or hexadecane. If present, the amount of the costabilizer 109 in the mixture 102 may be from 1 to 5 percent by volume (vol %), preferably from 2 to 4 vol %. One possible explanation for the increased stabilization that may be provided by a costabilizer is that the costabilizer can inhibit Ostwald ripening of the droplets in emulsion 112 and/or in microemulsion 122. Ostwald ripening in an emulsion polymerization is the inhomogeneous growth of droplets due to diffusion of polymerizer from smaller droplets to larger droplets. This diffusion may be driven by the increased solubility of the polymerizer in the larger droplets. A costabilizer may increase the hydrophobicity of the organic phase, thus reducing or eliminating any differences in solubility of the polymerizers between smaller droplets and larger droplets.

Dispersing (110) the mixture to form an emulsion 112 may be performed by a variety of techniques. Examples of dispersing techniques include high pressure jet homogenizing, vortexing, mechanical agitation, and magnetic stirring. Preferably the dispersing 110 includes mechanically agitating the mixture 102. Preferably, the order in which the components of the mixture 102 are mixed has little or no effect on the subsequent rate of polymerization of the first polymerizer 106. This may be provided by using an efficient homogenization process to prepare the emulsion 112.

The emulsion 112 includes droplets that include the first polymerizer 106 and the second polymerizer 108. Preferably, dispersing 110 includes agitation at a rate of 300 to 1000 revolutions per minute (rpm), including 350, 400, 450, 500, 550, 600, 700, 800, and 900 rpm. In conventional methods for making capsules, emulsions are formed solely by mechanical agitation, and there is a linear relation between log(droplet average diameter) and log(agitation rate). For example, at an agitation rate of 550 rpm, the average size of the droplet is 180±40 micrometers, whereas at an agitation rate of 1800 rpm, the average size is 15±5 micrometers (Brown et al. 2003).

Sonicating (120) the emulsion to form a microemulsion 122 can reduce the size of the droplets of the emulsion, such that the droplets in the microemulsion have an average diameter of 10 micrometers or less. Droplet size typically decreases with an increase in sonication power, an increase in sonication time, an increase in the amount of surfactant used, and/or a decrease in the volume fraction of the dispersed phase. One possible explanation for this reduction in droplet size is that ultrasound waves present during sonication can produce cavities that may be either oscillating or transient. Transient cavities have a lifetime less than the acoustic cycle and are more common in aqueous media. Cavitational intensity is maximal when cavitation is transient. The velocity of the wall when the cavity implodes could be as high as 150 meters per second (m/s). The turbulence created by this process, along with the shock waves, can tear off the droplets near the collapsing cavity. To further reduce the emulsion droplet size to an average diameter in the sub-micrometer range (for example, 100 nanometers to 1 micrometer), it may be desirable to reduce or eliminate Ostwald ripening in emulsion 122, such as by including optional costabilizer 109 in mixture 102.

The sonicating 120 may be performed simultaneously with at least a portion of the dispersing 110. One potential problem associated with sonicating with a sonifier is that only a small region of the emulsion 112 around the sonifier tip may be directly affected by the ultrasound waves. During sonication 120, additional agitation can be used to allow all the fluid of the emulsion 112 to pass through the sonication system. The droplet size of microemulsion 122 may depend on the agitation rate of process 110 and/or the time of sonication process 120. For example, a microemulsion 122 prepared at an agitation rate of 600 rpm may require 4 minutes of sonication time, whereas a microemulsion 122 prepared at an agitation rate of 1200 rpm may require 2 minutes of sonication time.

Polymerizing (130) the first polymerizer to form capsules includes polymerizing the first polymerizer 106. The capsules thus include at least a portion of the second polymerizer within the capsules 132. The polymerizing 130 may be performed simultaneously with at least a portion of the dispersing 110. Preferably, the conditions of process 130 are selected to cause polymerization of the first polymerizer 106 without causing polymerization of the second polymerizer 108. The choice of polymerization conditions may depend on the identity of the first polymerizer 106. For example, a first polymerizer 106 composed of urea and formaldehyde as components can form a urea-formaldehyde polymeric capsule shell under acidic conditions and elevated temperature. Capsules also can form from a first polymerizer 106 that is polymerized in the presence of an activator for the first polymerizer. For example, a first polymerizer 106 including isocyanates and diols can form a polyurethane capsule shell by adding diazobicyclo[2.2.2]octane as an activator in the polymerization process 130. In another example, a first polymerizer 106 including urea as a urea-formaldehyde polymer precursor can form a urea-formaldehyde capsule by including formaldehyde as an activator in the polymerization process 130.

Collecting (150) the capsules may include separating the polymerized capsules 132 from the remaining components of the microemulsion 122, including the surfactant 104, unpolymerized first polymerizer 106, non-encapsulated second polymerizer 108, and optional other ingredients, such as optional costabilizer 109. Preferred collection methods include filtration, centrifugation, and sedimentation. Preferably the collecting 150 includes filtration. The collecting 150 optionally may include washing the polymerized capsules 132, for example to remove surfactant 104. Examples of washing liquids include water, methanol and ethanol. Preferably the collecting 150 includes washing the polymerized capsules 132 with methanol. The capsules 132 may be dried before further use.

In one example of method 100, the dispersing 110 includes agitating a mixture of water and the surfactant 104, adding a mixture including the first polymerizer 106 to form a first emulsion, and adding the second polymerizer 108 to the first emulsion to form the emulsion 112. The sonicating 120 includes sonicating the second emulsion to form a microemulsion 122, while continuing the agitation. The polymerizing 130 includes adding an activator to the microemulsion and heating the microemulsion, while continuing the agitation. The collecting 150 includes stopping the agitation and allowing the mixture to cool from the temperature of the polymerizing 130.

The capsules may be homogenous in size. Preferably, for a given set of conditions and ingredients, process 100 produces capsules 132 having an average outer diameter less than 10 micrometers, with a standard deviation less than 60% of the average. More preferably, the standard deviation of the average outer diameter is less than 50% of the average, more preferably less than 40% of the average, and more preferably less than 30% of the average. The sizes of the capsules may be measured by a variety of techniques. In one example, capsule size is measured by optical microscopy coupled with image analysis software. The surface morphology and wall thickness of the capsules may be measured by scanning electron microscopy (SEM). The fill content of the capsules may be measured by elemental analysis, such as by analysis with a carbon-hydrogen-nitrogen (CHN) analyzer.

Capsules having an average outer diameter less than 10 micrometers and including a polymerizer can have a variety of desirable features. The size of the capsules can be uniformly small. The capsule wall thickness also can be uniform between different capsules. The outer surfaces of the capsules can be smooth and free from debris formed by the capsule polymer. The capsules can have good thermal stability. The polymerizer content can be at least 90 vol %, providing for efficient delivery of polymerizer to a crack in a composite in which the capsules are included. The presence of the capsules in a composite material may provide for fracture toughening of the composite.

Capsules having an average outer diameter less than 10 micrometers, such as the capsules produced by process 100, preferably include a polymerizer. The capsules isolate the polymerizer from the environment in which the capsules are used. Preferably the capsules have an average outer diameter of 10 nanometers (nm) to less than 10 micrometers. More preferably, the capsules have an average outer diameter of 10 nm to 5 micrometers. More preferably, the capsules have an average outer diameter of 10 nm to 2.5 micrometers. The capsules have an aspect ratio of 1:1 to 1:10, preferably 1:1 to 1:5, more preferably 1:1 to 1:3, more preferably 1:1 to 1:2, and more preferably 1:1 to 1:1.5.

The capsules are hollow, having a capsule wall enclosing an interior volume containing the polymerizer. For spherical capsules having an aspect ratio of about 1:1, the interior volume may be from 0.5 femtoliter to 5 picoliters. Preferably spherical capsules have an interior volume of 0.9 femtoliter to 4.2 picoliters. The wall thickness of the capsule may be from 30 nm to 150 nm, including 50, 60, 75, 90, 100, 110, 115, 120, 125, 130, and 135 nm. Preferably the capsules have an average wall thickness of 50 nm to 90 nm. The selection of a capsule wall thickness may depend on a variety of parameters, including the nature of the polymer matrix into which the capsules are to be dispersed. For example, capsule walls that are too thick may not rupture when a crack approaches, while capsules walls that are too thin may break during processing.

The capsules contain a polymerizer, which may include a polymerizable substance such as a monomer, a prepolymer, or a functionalized polymer having two or more reactive groups. The polymerizer optionally may contain other ingredients, such as other monomers and/or prepolymers, stabilizers, solvents, viscosity modifiers such as polymers, inorganic fillers, odorants, colorants and dyes, blowing agents, antioxidants, and co-catalysts. A polymerizer may also contain one part of a two-part catalyst, with a corresponding initiator being the other part of the two-part catalyst. The polymerizer preferably is capable of flowing when contacted by a crack in a composite in which the capsules are dispersed. Preferably, the polymerizer is a liquid.

Examples of polymerizable substances include cyclic olefins, preferably containing 4-50 carbon atoms and optionally containing heteroatoms, such as dicyclopentadiene (DCPD), substituted DCPD, norbornene, substituted norbornene, cyclooctadiene, and substituted cyclooctadiene. Examples of polymerizable substances also include unsaturated monomers such as acrylates, alkylacrylates (including methacrylates and ethacrylates), styrenes, isoprene and butadiene. Examples of polymerizable substances also include lactones (such as caprolactone) and lactams, which, when polymerized, will form polyesters and nylons, respectively. Examples of polymerizable substances also include epoxy-functionalized monomers, prepolymers or polymers.

Examples of polymerizable substances also include polymerizable substances that include functionalized siloxanes, such as siloxane prepolymers and polysiloxanes having two or more reactive groups. Functionalized siloxanes include, for example, silanol-functional siloxanes, alkoxy-functional siloxanes, and allyl- or vinyl-functional siloxanes. Self-healing materials that include functionalized siloxanes as polymerizers are disclosed, for example, in U.S. Patent Application Publication 2006/0252852 A1 with inventors Braun et al., published Nov. 9, 2006; and in U.S. patent application Ser. No. 11/620,276 with inventors Braun et al., filed Jan. 5, 2007.

The polymerizer in the capsules may contain a two-part polymerizer, in which two different substances react together to form a polymer when contacted with an activator. Examples of polymers that can be formed from two-part polymerizer systems include polyethers, polyesters, polycarbonates, polyanhydrides, polyamides, formaldehyde polymers (including phenol-formaldehyde, urea-formaldehyde and melamine-formaldehyde), and polyurethanes. For example, a polyurethane can be formed by the reaction of one compound containing two or more isocyanate functional groups (—N═C═O) with another compound containing two or more hydroxyl functional groups (—OH).

Capsules having an average outer diameter less than 10 micrometers and including a polymerizer may be present in a composite material. Such a composite material includes the capsules containing the polymerizer, an activator, and a polymer matrix. The capsules isolate the polymerizer from the environment in which the polymer matrix is made and/or used, and may also isolate the polymerizer from the activator.

The activator may be a catalyst or an initiator. Preferably the activator is a corresponding activator for the polymerizer. In one example, corresponding catalysts for polymerizable cyclic olefins include ring opening metathesis polymerization (ROMP) catalysts such as Schrock catalysts (Bazan et al., (1991)) and Grubbs catalysts (Grubbs et al., (1998)). In another example, corresponding catalysts for lactones and lactams include cyclic ester polymerization catalysts and cyclic amide polymerization catalysts, such as scandium triflate.

In another example, corresponding activators for epoxy polymers include any activator that can react with two or more epoxy functional groups. For example, an epoxy polymer can be formed by the reaction at or below room temperature (for example, 25° C.) of one compound containing two or more epoxy functional groups with another compound containing either at least one primary amine group or at least two secondary amine groups. In these systems, an amine compound can be present in a composite as the activator for an epoxy-functionalized polymerizer.

Corresponding activators for the polymerizer may be two-part activators, in which two distinct substances must be present in combination for the activator to function. In one example of a two-part catalyst system, one part of the catalyst may be a tungsten compound, such as an organoammonium tungstate, an organoarsonium tungstate, or an organophosphonium tungstate; or a molybdenum compound, such as organoammonium molybdate, an organoarsonium molybdate, or an organophosphonium molybdate. The second part of the catalyst may be an alkyl metal halide, such as an alkoxyalkyl metal halide, an aryloxyalkyl metal halide, or a metaloxyalkyl metal halide in which the metal is independently tin, lead, or aluminum; or an organic tin compound, such as a tetraalkyltin, a trialkyltin hydride, or a triaryltin hydride.

In another example of a two-part activator system, a corresponding polymerizer may contain unsaturated polymerizable compounds, such as acrylates, alkylacrylates (including methacrylates and ethacrylates), styrenes, isoprene, and butadiene. In this example, atom transfer radical polymerization (ATRP) may be used, with one of the two components being mixed with the polymerizable compound and the other acting as the initiator. One component can be an organohalide such as 1-chloro-1-phenylethane, and the other component can be a copper(I) source such as copper(I) bipyridyl complex. In another exemplary system, one component could be a peroxide such as benzoyl peroxide, and the other component could be a nitroxo precursor such as 2,2,6,6-tetramethylpiperidinyl-1-oxy. These systems are described in Stevens (1999, pp. 184-186).

In another example of a two-part activator system, a corresponding polymerizer may contain isocyanate functional groups (—N═C═O) and hydroxyl functional groups (—OH). In one example of this type of system, the polymerizer may be a compound containing both an isocyanate group and a hydroxyl group. In another example of this type of system, the polymerizer may include two different compounds, one compound containing at least two isocyanate groups and the other compound containing at least two hydroxyl groups. The reaction between an isocyanate group and a hydroxyl group can form a urethane linkage (—NH—C(═O)—O—) between the compounds, possibly releasing carbon dioxide. This carbon dioxide can provide for the creation of expanded polyurethane foam. Optionally, the polymerizer may contain a blowing agent, for example a volatile liquid such as dichloromethane. In these systems, condensation polymerization may be used, with one of the two components being mixed with the polymerizer and the other acting as the initiator. For example, one component could be an alkylating compound such as stannous 2-ethylhexanoate, and the other component could be a tertiary amine such as diazabicyclo[2.2.2]octane. These systems are described in Stevens (1999, pp. 378-381).

The activator for the polymerizer optionally may be present in the composite in capsules. Activator capsules may be formed by a process similar to process 100, replacing the second polymerizer 108 with an activator. Activator capsules keep the activator separate from the polymerizer capsules until subjected to a crack in a composite in which the capsules are dispersed. The activator and the polymerizer can come into contact to form a polymer in the crack. An activator in capsules may be present with other ingredients, such as stabilizers, solvents, viscosity modifiers such as polymers, inorganic fillers, odorants, colorants and dyes, blowing agents, antioxidants and co-catalysts. If the polymerizer is a two-part polymerizer, then one of the polymerizable substances may be present in the capsules with the activator, as long as the polymerizable substance does not consume the activator. If the activator is a two-part activator, the two parts of the activator may be in separate capsules. One part of the activator may also be present in the polymerizer capsules. One part of the activator may be present in the composite without being in a capsule. The activator may be a general activator for polymerization, or it may be a corresponding activator for the specific polymerizer present in the capsules. A wide variety of activators can be used, including activators that are low in cost and easy to process into capsules.

The polymer matrix may be any polymeric material into which the activator and the capsules may be dispersed. Examples of polymer matrices include polyamides such as nylons; polyesters; epoxy polymers; epoxy vinyl ester polymers; polyimides such as polypyromellitimide (for example, KAPTAN); amine-formaldehyde polymers; such as melamine polymer; polysolfones; poly(acrylonitrile-butadiene-styrene) (ABS); polyurethanes; polyolefins such as polyethylene, polystyrene, polyacrylonitrile, polyvinyls, polyvinyl chloride, and poly(PCPD); polyacrylates such as poly(ethyl acrylate); poly(alkylacrylates) such as poly(methyl methacrylate); polysilanes; and polyphosphazenes. Examples of polymer matrices also include elastomers, such as elastomeric polymers, copolymers, block copolymers, and polymer blends. Self-healing materials that include elastomers as the polymer matrix are disclosed, for example, in U.S. patent application Ser. No. 11/421,993 with inventors Keller et al., filed Jun. 2, 2006.

The polymer matrix can include other ingredients in addition to the polymeric material. For example, the matrix can contain stabilizers, antioxidants, flame retardants, plasticizers, colorants and dyes, fragrances, particulates, reinforcing fibers, and adhesion promoters. One type of adhesion promoter that may be present includes substances that promote adhesion between the polymer matrix and the capsules. The adhesion between the matrix and the capsules may influence whether the capsules will rupture or debond in the presence of an approaching crack. To promote the adhesion between the polymer and the capsule wall, various silane coupling agents may be used. Typically, these are compounds of the formula R—SiX₃ , where R is preferably a reactive group R¹ separated by a propylene group from silicon, and X is an alkoxy group (preferably methoxy). Examples of compounds of this formula include R¹—CH₂CH₂CH₂Si(OCH₃)₃. Specific examples include silane coupling agents available from DOW CORNING (with reactive group following the name in parentheses): Z6020 (Diamino); Z6030 (Methacrylate); Z6032 (Styrylamine Cationic); Z6040 (Epoxy); and Z6075 (Vinyl). To increase the adhesion between the capsules and the polymer matrix, the capsules may be treated by washing them in a solution of the coupling agent. For example, urea-formaldehyde capsules may be washed in a solution of Silane Z6020 or Z6040 and hexane (1:20 weight ratio) followed by adding Silane Z6032 to the polymer matrix at a loading of 1 percent by weight (wt %).

Another type of adhesion promoter that may be present includes substances that promote adhesion between the polymer matrix and the polymer formed from the polymerizer when contacted with the activator. The adhesion between the matrix and this polymer may influence whether the composite can be healed once a crack has been introduced. To promote the adhesion between the polymer matrix and the polymer formed in the crack, various unsaturated silane coupling agents may be used. Typically, these are compounds of the formula R²—SiX′X″X′″, where R² is preferably an unsaturated group R³ separated by a propylene group from silicon; and X′, X″ and X′″ are independently alkyl or alkoxy, such that at least one of X′, X″ and X′″ is an alkoxy group (preferably ethoxy). Examples of compounds of this formula include R³—CH₂CH₂CH₂Si(OCH₂CH₃)₃. Specific examples include silane coupling agents available from GELEST, such as (3-acryloxypropyl)-trimethoxysilane, (3-acryloxypropyl)methyldimethoxysilane, methacryloxypropyl-trimethoxysilane, methacryloxypropylmethyld imethoxysi lane, methacryloxypropyl-triethoxysi lane, methacryloxypropylmethyidiethoxysilane, 3-glycidoxypropyl-trimethoxysilane, and N-2-aminoethyl-3-aminopropyl-trimethoxysilane. To increase the adhesion between the polymer matrix and the polymer formed in the crack, the adhesion promoter can be mixed with the matrix precursor before the final composite is formed.

A method of making a composite includes mixing ingredients including a matrix precursor, an activator, and capsules containing a polymerizer, and solidifying the matrix precursor to form a polymer matrix. The method may further include forming capsules containing the polymerizer and/or forming capsules containing the activator. The matrix precursor may be any substance that can form a polymer matrix when solidified.

In one example, the matrix precursor includes a monomer and/or prepolymer that can polymerize to form a polymer. The polymerizer capsules and the activator may be mixed with the monomer or prepolymer. The matrix precursor may then be solidified by polymerizing the monomer and/or prepolymer of the matrix precursor to form the polymer matrix.

In another example, the matrix precursor includes a solution or dispersion of a polymer in a solvent. The polymer may be dissolved in a solvent to form the matrix precursor, and the capsules then mixed into the matrix precursor. The matrix precursor may be solidified by removing solvent from the composition to form the polymer matrix.

In another example, the matrix precursor includes a polymer that is at a temperature above its melting temperature. The polymer may be melted to form the matrix precursor and then mixed with the capsules. The matrix precursor may be solidified by cooling the composition to a temperature below the melt temperature of the polymer to form the polymer matrix.

A composite containing a polymer matrix, an activator, and capsules containing a polymerizer can be self-healing. When the composite is subjected to a crack, the activator and polymerizer can come into contact to form a polymer in the crack. It is desirable for the activator and the capsules containing the polymerizer to be dispersed throughout the composite, so that a crack will intersect the activator and one or more capsules of the polymerizer, breaking the capsules.

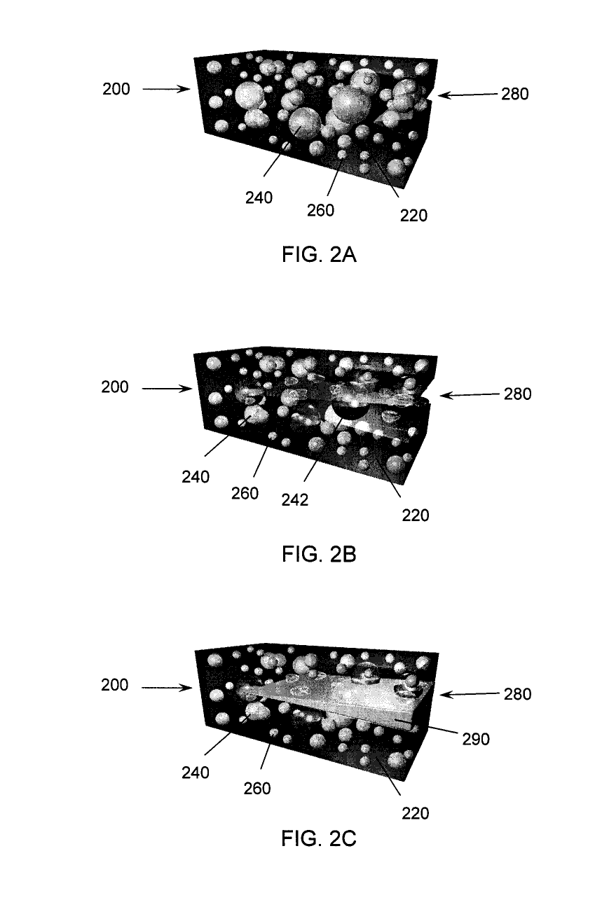

FIG. 2A illustrates a composite 200 having a polymer matrix 220, capsules 240 containing a polymerizer, and an activator 260. A crack 280 has begun to form in the composite. FIG. 2B illustrates this composite when the crack has progressed far enough to intersect polymerizer capsules and the activator. Broken capsules 242 indicate that the polymerizer has flowed into the crack. FIG. 2C illustrates the composite after the polymerizer and the activator have been in contact for a time sufficient to form a polymer 290 that fills the space from the crack.

### EXAMPLES

### Example 1

### Formation of Capsules Containing Polymerizer

Capsules containing dicyclopentadiene (DCPD) monomer were prepared by in situ polymerization of urea and formaldehyde. DCPD was slowly added to a room temperature solution of ethylene-maleic anhydride (EMA) copolymer (Zemac-400 EMA), urea, resorcinol and ammonium chloride and allowed to equilibrate under stirring conditions for 10 minutes. For some capsule batches, either hexadecane or octane was added to the mixture as a costabilizer. A tapered ⅛-inch tip sonication horn of a 750-Watt ultrasonic homogenizer (Cole-Parmer) was placed in the mixture. The sonication horn was operated for 3 minutes at 40% intensity, corresponding to approximately 3.0 kilojoules (kJ) of input energy. The mixture was mixed at 800 rpm during sonication. This sonication changed the emulsion from slightly cloudy to opaque white. Formalin (37 wt % aqueous solution of formaldehyde) was added to provide a 1:1.9 molar ratio of formaldehyde to urea, which polymerized to form a urea-formaldehyde polymer. The temperature control bath was slowly heated and held constant for 4 hours of polymerization. At the completion of the polymerization, the mechanical agitation and heating were stopped, and the pH was adjusted to 3.50 with sodium hydroxide.

The procedure for a specific exemplary batch was as follows. An aqueous composition was prepared by combining 20 milliliters (mL) deionized water and 8.5 mL of a 5.0 wt % solution of EMA in water. The aqueous composition was agitated at 800 rpm, at room temperature. Once agitation had begun, a mixture of 0.50 gram (g) urea, 0.05 g resorcinol, and 0.10 g NH₄Cl was added to the composition. DCPD (5.50 mL) was slowly added to the mixture, and agitation was continued for 10 minutes. A tapered ⅛-inch tip sonication horn of a 750-Watt ultrasonic homogenizer was placed in the mixture and operated for 3 minutes at 40% intensity (˜3.0 kJ of input energy), while agitation continued. Formalin (1.16 g) was added, and the temperature was raised to 55° C. at a rate of 1° C. per minute. The mixture was agitated at 55° C. for 4 hours, after which the pH was adjusted to 3.50 with sodium hydroxide.

### Comparative Example

### Formation of Capsules having an Average Outer Diameter Greater than 10 Micrometers

Larger capsules containing dicyclopentadiene (DCPD) monomer were prepared by in situ polymerization of urea and formaldehyde, according to the procedure of Brown et al., “In situ poly(urea-formaldehyde) microencapsulation of dicyclopentadiene” J. Microencapsulation 20(6), 719-730, 2003. At room temperature (20-24° C.), 200 mL of deionized water and 50 mL of a 2.5 wt % aqueous solution of EMA copolymer were mixed in a 1000 mL beaker. The beaker was suspended in a temperature controlled water bath on a programmable hotplate with external temperature probe. The solution was agitated with a digital mixer driving a three-bladed, 63.5 millimeters (mm) diameter low-shear mixing propeller placed just above the bottom of the beaker. The agitation rate was varied from 200 to 2,000 rpm. Under agitation, 5.00 g urea, 0.50 g ammonium chloride and 0.50 g resorcinol were dissolved in the solution. The pH was raised from 2.60 to 3.50 by drop-wise addition of sodium hydroxide (NaOH) and hydrochloric acid (HCl). One to two drops of 1-octanol were added to eliminate surface bubbles. A slow stream of 60 mL of DCPD was added to form an emulsion and allowed to stabilize for 10 minutes. After stabilization, 12.67 g of a 37 wt % aqueous solution of formaldehyde was added to obtain a 1:1.9 molar ratio of formaldehyde to urea. The emulsion was covered and heated at a rate of 1° C. per minute to the target temperature of 55° C. After 4 hours of continuous agitation, the mixer and hot plate were switched off. Once cooled to ambient temperature, the suspension of capsules was separated under vacuum with a coarse-fritted filter. The capsules were rinsed with deionized water and air dried for 24-48 h. A sieve was used to aid in separation of the capsules.

### Example 2

### Microscopy of Capsules

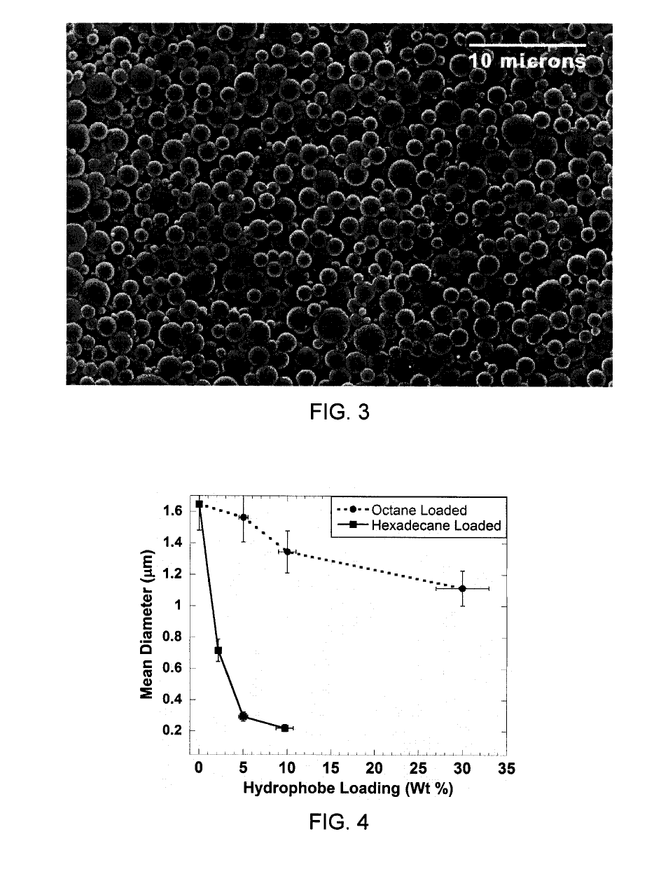

Capsules from Example 1 were mounted on glass slides and dried in a vacuum oven. The capsules were ruptured with a razor blade and subjected to sputtering with a thin layer (˜10 nm) of gold-palladium to prevent charging under the electron beam. The capsules were then imaged by SEM at 5.0 kV accelerating voltage, with a spot size of 3.0 to minimize sample charging. The SEM images revealed that the capsules were spherical in shape, nearly monodisperse in capsule outer diameter, and had a smooth non-porous wall. Images of the capsules showed spherical capsules, free of surface debris with well formed walls. FIG. 3 is a scanning electron microscopy (SEM) image of capsules formed in Example 1. For lower concentrations of EMA surfactant, the capsules formed aggregates that were inseparable by ultrasonication, stirring, and solvent washing. In contrast, capsules formed with the EMA surfactant concentration used in Example 1 were easily dispersed in an epoxy precursor.

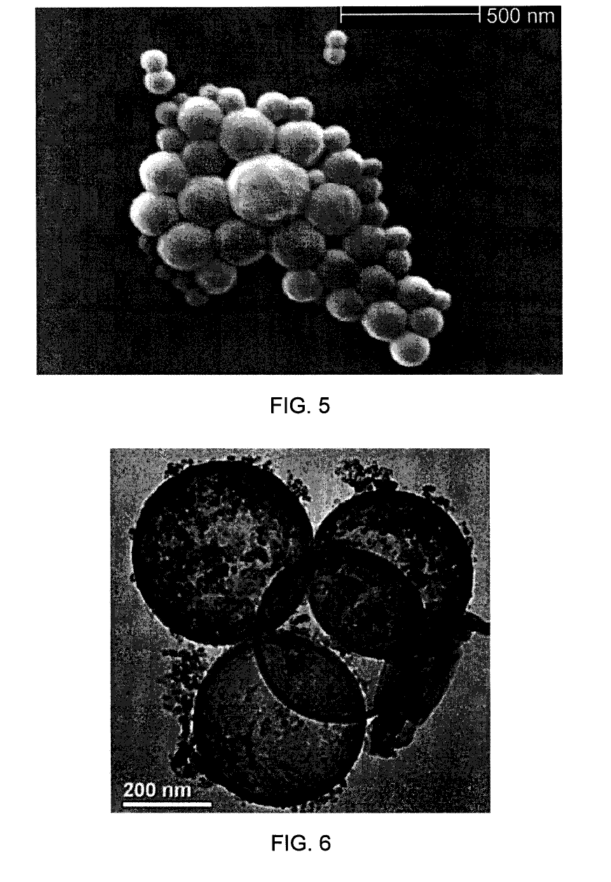

Capsule size analysis was performed by two different methods, SEM and focused extinction (PSS Accusizer FX). Focused extinction average values were calculated from over 50,000 measurements. SEM average values were calculated from a minimum of 200 individual measurements obtained from photomicrographs. The capsules prepared with a core material of pure DCPD had an average outer diameter of 1.56±0.50 micrometer as measured by focused extinction, and 1.65±0.79 micrometer as measured by SEM. Capsules prepared from mixtures that included a costabilizer with the DCPD had a smaller average outer diameter. FIG. 4 illustrates the reduction in average outer diameter of capsules as the concentration of either octane or hexadecane in the DCPD mixture is increased. The smallest capsules were obtained for a DCPD mixture that included 10 wt % hexadecane as a costabilizer. These capsules had an average outer diameter of 220±113 nm as measured by SEM. FIG. 5 is an SEM image of capsules formed from a mixture that included 10 wt % hexadecane as a costabilizer. FIG. 6 is a transmission electron microscopy (TEM) image of these capsules, showing the walls of the capsules.

In contrast, the capsules of the Comparative Example had an average outer diameter of 10 to 1,000 micrometers, with higher agitation rates producing smaller capsules. Specifically, capsules of the Comparative Example prepared with an agitation rate of 550 rpm had an average outer diameter of 183±42 micrometers, while capsules prepared with an agitation rate of 1,800 rpm had an average outer diameter of 15±5 micrometers.

Capsule wall thicknesses were measured directly from SEM images of the fracture surfaces for capsules containing DCPD without costabilizer. Measurements were collected from two independent batches using image analysis software. The average capsule wall thickness was 77±25 nm (n=106). In contrast, the capsules of the Comparative Example had substantially thicker walls of 160-220 nm.

### Example 3

### Thermal Stability of Capsules

Thermal stability of the capsules of Example 1 was measured by thermogravimetric analysis (TGA). Capsules were dried at 80° C. for 2 h before thermal testing to remove residual water. The capsules retained over 95% of their weight below 100° C., and this weight loss was correlated to residual water. A sharp weight loss then occurred from 150° C. to 220° C. This weight loss occurred near the boiling point of DCPD (166° C.), indicating that the capsules were stable until the DCPD vaporized and ruptured the capsules.

### Example 4

### Composition of Capsules

The fill content of the capsules of Example 1 was examined by gas chromatography to determine the amount of DCPD in the processed capsules. Prior to testing, blank traces of methylene chloride, endo-DCPD, and exo-DCPD were used to determine the correlation of peaks to specific chemical compounds. Following a drying period (12 hours at 80° C.), the capsules were placed in methylene chloride. The mixture of methylene chloride and capsules was sealed and allowed to stand for 1 week in order to allow the DCPD sufficient time to diffuse from the capsules into the solvent. Gas chromatography was then performed on the filtered solution and confirmed the presence of both the endo and exo isomers of DCPD that were expected to be present in distilled DCPD (Sudduth 2006).

Elemental decomposition data was used to estimate the DCPD and urea-formaldehyde (UF) content of the capsules. The carbon, hydrogen, and nitrogen content (CHN) of the capsules was measured by combustion of a sample of prepared capsules and analysis of the products (Exeter Analytical CE440). Since the UF capsule wall was the only compound in the sample containing nitrogen, the mass percent of the UF followed directly from the measured nitrogen mass percent. The DCPD mass percent was then calculated from the UF mass percent and the measured carbon mass percent.

From the CHN data, the average microcapsule DCPD content by mass was 78.4%. To determine the percent of filled volume in the capsules, a simple sphere in sphere model was used to represent the core-shell morphology of the capsule. Based on measured values of capsule wall thickness, the average outer diameter, and the densities of DCPD (0.976 g/cm³) and UF (˜1.15 g/cm³), the average capsule fill percentage was estimated to be 94% by volume.

### Example 5

### Zeta-Potential of Capsules

The zeta-potential of the capsules of Example 1 was studied to determine the ideal storage and processing pH for the capsules to avoid aggregation. Capsule solutions were prepared at pH levels ranging from 2-10 and were analyzed immediately after preparation to avoid agglomeration and sedimentation. The zeta-potential was measured by electrophoresis for each pH level (Malvern Zetasizer). Each data point was the average of at least 10 measurements from 2 independent batches. The isoelectric point (IEP) for the capsules was located approximately at pH 2.2.

The encapsulation process used in Example 1 ended with an adjustment of the pH to 3.5 in order to increase the zeta-potential and prevent aggregation. Particles with a zeta-potential greater than 30 mV were considered electrostatically stable (Tvergaard et al. 1992). Agglomeration was minimized by adjusting the pH to a value between 3.5 and 4.0 before storage and processing. Higher pH values were not used because high alkalinity degraded the capsule walls over long periods of time.

### Example 6

### Formation of Composite Containing Capsules

Capsules of Example 1 were cooled in an ice bath to ensure dispersion stability. Anhydrous magnesium sulfate, a drying agent, was added to the aqueous capsule mixture, and the capsules were washed with a solvent to remove excess EMA surfactant. The resulting mixture was centrifuged to separate the capsules from the liquid. Multiple washes and centrifugation steps were used to remove excess water and surfactant. The resulting capsules were allowed to air dry for up to 30 minutes. The capsules were then dispersed in an epoxy precursor, including epoxy prepolymer EPON 828 and curing agent diethylenetriamine (DETA; Ancamine®, AIR PRODUCTS), using ultrasonication and high speed stirring. The epoxy precursor mixture was placed into a mold and allowed to cure into a rigid composite.

Homogeneous capsule dispersion in epoxy was affected by factors including capsule drying time, capsule size, epoxy sonication time, capsule separation method, and various capsule preparation parameters. The optimal capsule dry time appeared to be between 10 to 15 minutes at ambient conditions. The optimal dispersion parameters appeared to be ultrasonication using 40% intensity of a 750 Watt sonifier for 5-10 minutes.

### Example 7

### Mechanical Properties of Composite Containing Capsules

Composites prepared according to Example 6 were analyzed for a variety of mechanical properties. Fracture toughness was measured using a tapered double cantilever beam (TDCB) sample. Tensile strength was measured using a dog-bone sample. Elastic modulus was measured using prismatic rectangular bars prepared for dynamic mechanical analysis (DMA). All test samples were subjected to the same curing conditions at 25° C. for 24 hours, followed by heating in an oven at 35° C. for 24 hours immediately prior to testing. For imaging of the capsules in the composite, cylindrical samples having a diameter of 8 mm and a height of 16 mm were frozen in liquid nitrogen and fractured with a razor blade.

Measurements of the mode-I fracture toughness (K_{IC}) was investigated over a range of capsule concentrations. K_{IC} increased significantly with capsule volume fraction. A 59% increase in fracture toughness was achieved for a capsule volume fraction of 0.015. The increase in fracture toughness per volume fraction of capsules was substantially higher for composites including the capsules of Example 1 than for composites including the capsules of the comparative example.

The fracture surfaces associated with the capsules contained tail structures consistent with increased fracture toughness. Near the crack tip, tail structures extended an average length of 86 micrometers (n=130) along the fracture surface. In contrast, the tails associated with the larger capsules of the comparative example extended an average of 128 micrometers (n=60). Thus, the ratio of tail length to average outer diameter was significant for the capsules of Example 1. One possible explanation for the increased fracture toughness is that the capsules contributed to crack deflection in the composite. SEM imaging of ruptured capsules of Example 1 indicated characteristic crack tail behavior associated with crack deflection, as reported in previous nanoparticle fracture studies (Rule et al. 2002; Zhang et al. 2006).

Measurements of the ultimate tensile strength were obtained by applying a load of 1 millimeter per minute to each sample. A 30% drop in tensile strength was observed for a capsule loading of 2% by volume. This decrease in tensile strength was similar to that observed for composites having the larger capsules of the comparative example. The decrease in tensile strength for both sizes of capsules was consistent with empirical models from the literature for composite tensile strength (White et al. 2001).

Measurements of the elastic modulus were obtained by dynamic mechanical analysis (DMA). The elastic modulus was measured for composites having a variety of capsule sizes and capsule volume fractions. Only a negligible change in modulus from that of the neat epoxy resin was observed with the addition of 0.5-2.0% volume fraction of the capsules of Example 1. In contrast, Rzeszutko et al. (2005) reported a proportional decrease in elastic modulus with increasing volume fraction of capsules that had an average outer diameter of 180 micrometers.

### Prophetic Example

### Formation of Self-Healing Composite

Capsules of Example 1 are cooled in an ice bath to ensure dispersion stability. Anhydrous magnesium sulfate is added to the aqueous capsule mixture, and the capsules are washed with a solvent to remove excess EMA surfactant. The resulting mixture is centrifuged to separate the capsules from the liquid. Multiple washes and centrifugation steps are used to remove excess water and surfactant. The resulting capsules are allowed to air dry for 10 to 15 minutes.

An epoxy precursor is prepared by mixing 100 parts epoxy prepolymer EPON 828, 12 parts epoxy curing agent DETA (Ancamine®), and 2.5 wt % Grubbs catalyst. The capsules are then dispersed in the epoxy precursor using ultrasonication and high speed stirring. The epoxy precursor mixture is placed into a mold and cured for 24 hours at room temperature, followed by postcuring at 40° C. for 24 hours to form a self-healing composite.

To assess the crack healing efficiency of the self-healing composite, fracture tests are performed using a 4-point bend test. This test provides for a smaller crack volume than the crack volume typically present in a TDCB test sample. Preferably the test involves a crack separation of approximately 1-2 micrometers. Control samples include (1) neat epoxy containing no Grubbs' catalyst or capsules, (2) epoxy with Grubbs' catalyst but no capsules and (3) epoxy with capsules but no catalyst. A sharp pre-crack is created in each sample, and a load is applied in a direction parallel to the pre-crack. The virgin fracture toughness is determined from the critical load to propagate the crack and fail the specimen. After failure, the load is removed, and the crack is allowed to heal at room temperature with no manual intervention. Fracture tests are repeated after 48 hours to quantify the amount of healing.

While various embodiments of the invention have been described, it will be apparent to those of ordinary skill in the art that other embodiments and implementations are possible within the scope of the invention. Accordingly, the invention is not to be restricted except in light of the attached claims and their equivalents.

### REFERENCES

1. Bazan et al., Macromolecules 24, 4495-4502 (1991).
2. Brown et al., In situ poly(urea-formaldehyde) microencapsulation of dicyclopentadiene. Journal of Microencapsulation 2003; 20(6): 719.
3. Grubbs et al., Tetrahedron 54, 4413-4450 (1998).
4. Rule et al., ROMP reactivity of endo- and exo-dicyclopentadiene. Macromolecules 2002; 35(21): 7878.
5. Rzesutko et al., Tensile Properties of Self-Healing Epoxy. TAM Technical Reports 2003; 1041.
6. Stevens et al., Polymer Chemistry: An Introduction, 3rd Edition; (Oxford University Press, New York, (1999)), 184-186; 378-381.
7. Sudduth, Analysis of the Maximum Tensile Strength of a Composite with Spherical Particulates. Journal of Composite Materials 2006; 40(4): 301.
8. Tvergaard, Effect of ductile particle debonding during crack bridging in ceramics. International Journal of Mechanical Sciences 1992; 34(8): 635.
9. White et al., Autonomic healing of polymer composites. Nature 2001; 409(6822): 794
10. Zhang et al., Binary mixed solvents for separating benzene-cyclohexane by extractive distillation. Journal of Tianjin University Science and Technology 2006; 39(4): 424-427.
11. IUPAC, Compendium of Chemical Terminology: IUPAC Recommendations, 2^{nd} ed., compiled by A. D. McNaught and A. Wilkinson, Blackwell, Oxford (1997).
12. U.S. Pat. No. 6,518,330 to White et al., issued Feb. 11, 2003.
13. U.S. Patent Application Publication 2006/0252852 A1 to Braun et al., published Nov. 9, 2003.

1. A composition, comprising:
a plurality of capsules, and
a polymerizer, in the capsules;
where the capsules have an average outer diameter less than 10 micrometers.

2. The composition of claim 1, where the capsules have an average outer diameter of 100 nanometers to 5 micrometers.

3. The composition of claim 1, where the capsules have an average outer diameter of 100 nanometers to 2.5 micrometers.

4. The composition of claim 1, where the capsules have an interior volume of 0.5 femtoliter to 5 picoliters.

5. The composition of claim 1, where the capsules have an interior volume of 0.9 femtoliter to 4.2 picoliters.

6. The composition of claim 1, where the polymerizer accounts for 90% of the volume of the capsules.

7. The composition of claim 1, where the capsules comprise a capsule shell comprising a polymer selected from the group consisting of a urea-formaldehyde polymer, a polyurethane, a gelatin, a polyurea, a polystyrene, and a polyamide.

8. The composition of claim 7, where the capsule shell comprises a urea-formaldehyde polymer.

9. The composition of claim 1, where the polymerizer comprises a member selected from the group consisting of a cyclic olefin, an unsaturated monomer, a lactone, a lactam, an epoxy-functional monomer, and a functionalized siloxane.

10. The composition of claim 1, where the polymerizer comprises dicyclopentadiene.

11. A method of making capsules, comprising:
sonicating an emulsion, to form a microemulsion,
the emulsion comprising water, a surfactant, a first polymerizer, and a second polymerizer; and
polymerizing the first polymerizer, to form capsules encapsulating at least a portion of the second polymerizer.

12. The method of claim 11, where the capsules have an average outer diameter less than 10 micrometers.

13. The method of claim 11, where the capsules have an average outer diameter of 100 nanometers to 5 micrometers, and an interior volume of 0.5 femtoliter to 5 picoliters.

14. The method of claim 11, where the emulsion further comprises a costabilizer.

15. The method of claim 14, where the costabilizer comprises a member selected from the group consisting of cetyl alcohol, hexadecane, octane, n-dodecyl mercaptan, poly(methyl methacrylate), and polystyrene.

16. The method of claim 11, where the surfactant comprises a member selected from the group consisting of a cationic surfactant, an anionic surfactant, an amphoteric surfactant, an ester surfactant, and a non-ionic surfactant.

17. The method of claim 11, where the surfactant comprises ethylene-maleic anhydride copolymer.

18. The method of claim 11, where the first polymerizer comprises a member selected from the group consisting of a urea-formaldehyde polymer precursor, a polyurethane precursor, a gelatin precursor, a polyurea precursor, a polystyrene precursor, and polyamide precursor.

19-20. (canceled)

21. A composite material, comprising:
a polymer matrix,
a plurality of capsules,
a polymerizer, in the capsules, and
an activator;
where the capsules have an average outer diameter less than 10 micrometers.

22-25. (canceled)

26. A method of making the composite material of claim 21, comprising:
combining the plurality of capsules and the activator with a matrix precursor, and
solidifying the matrix precursor to form the polymer matrix.

27-30. (canceled)
